(19) United States
(12) Patent Application Publication
(10) Pub. No.: US 2014/0147836 A1
(43) Pub. Date: May 29, 2014

(54) METHODS AND APPARATUS FOR IMAGING MOLECULES IN LIVING SYSTEMS

(71) Applicants: David Grunwald, Worcester, MA (US); Robert H. Singer, New York, NY (US)

(72) Inventors: David Grunwald, Worcester, MA (US); Robert H. Singer, New York, NY (US)

(73) Assignee: Albert Einstein College of Medicine of Yeshiva University, Bronx, NY (US)

(21) Appl. No.: 13/820,528

(22) PCT Filed: Sep. 13, 2011
(86) PCT No.: PCT/US11/51294

§ 371 Date: May 7, 2013

Related U.S. Application Data
(60) Provisional application No. 61/403,323, filed on Sep. 14, 2010.

(51) Int. Cl. G01N 21/64

(52) U.S. Cl. CPC G01N 21/6486
USPC 435/6.1; 435/29; 435/287.2

(57) ABSTRACT

Methods and apparatus are disclosed for imaging molecular interactions in living cells at high resolution, low light levels and high acquisition speeds.

### CROSS-REFERENCE TO RELATED APPLICATION

This application claims the benefit of U.S. Provisional Patent Application No. 61/403,323, filed on Sep. 14, 2010, the content of which is herein incorporated by reference into the subject application.

### STATEMENT OF GOVERNMENT SUPPORT

This invention was made with government support under grant numbers EB2060 and GM86217 awarded by the National Institutes of Health, U.S. Department of Health and Human Services. The government has certain rights in the invention.

### BACKGROUND OF THE INVENTION

Throughout this application various publications are referred to in brackets. Full citations for these references may be found at the end of the specification preceding the claims. The disclosures of these publications are hereby incorporated by reference in their entirety into the subject application to more fully describe the art to which the subject invention pertains.

The present invention addresses the need of imaging highly transient molecular interactions in living cells, which can occur over distances smaller than the optical resolution of conventional light microscopes. In addition, the classical use of co-localization in fluorescence microscopy suffers from possible misinterpretations concerning the actual proximity of interrogated components due to intrinsic errors in registration. The present invention allows investigations of molecular interactions in living cells at high resolution, low light levels and high acquisition speeds.

### SUMMARY OF THE INVENTION

The present invention provides methods for imaging molecules, where the methods comprise providing a multi channel marker that can be detected by multiple detection areas; labeling one or more types of molecules with a fluorescent marker, wherein different types of molecules are labeled with spectrally distinguishable fluorescent markers; spatially registering the multiple detection areas; recording a registration signal from the multi channel marker on the multiple detection areas; imaging the labeled molecules; evaluating the registration signal to obtain a transformation matrix for each pair of detection areas; and applying the transformation matrix to imaging data recorded on multiple detection areas to thereby image the molecules.

The invention also provides virtual fiducial markers for imaging comprising either a non-transparent mask containing one or more openings through which light can pass or a mask that is partially transparent and can generate a virtual signal suitable for sub-diffraction registration of multiple detection areas, wherein the mask is held in a translation stage that allows movement of the mask in x and y directions or an optical installation is used to move an image of the mask if it is not mounted in a stage; a first lens system on one side of the mask to deliver light onto the mask; and a second lens system on the opposite side of the mask from the first lens system to project an image of the mask into a sample to be imaged, thereby acting as a virtual fiducial marker.

### BRIEF DESCRIPTION OF THE DRAWINGS

FIG. 1A-1O. Super-Registration Precision and Detection of Nuclear mRNA. (A-G) The registration precision achieved in this experiment was based on imaging nuclear pores on two cameras immediately before data acquisition (SI). Data from both cameras (A) red, (B) green, merged image (C) after registration. A filtered merged image (D) with 21 nuclear pores, white circles outlined (E). (F) Coregistration precision between the best aligned 6 (black bars and black line in inset), 10 (light grey) and 15 (dark grey) nuclear pores. Fit (inset), Gaussian fit to the ‘15 pore’ data set: registration=10±1 nm, 13±1 nm FWHM. (G) Distances between pores in (E). Peak=7.5 nm. (H) mRNAs interacted with nuclear pores infrequently and not all interactions resulted in export of mRNAs from the nucleus. (I) Full length traces (H); first (dark box), last (light box). (J) Intensity trace (grey), tracked mRNA, background (black). (K) slow export images. (L) fast export. (M) Distances between mRNA and pore from (L) colocalization precision, 26 nm total (SI). Nucleoplasmic mRNA (+) cytoplasmic mRNA (−). (N) Intensity mRNA signal (grey) vs. background (black). (O) mRNA positions (gray boxes) and pores (circle) overlaid on nuclear pore from (L). Bars=2 μm, ‘n/c’=nucleus/cytoplasm, ‘max’=maximum intensity projection, (I) & (O) axis pixels (=64 nm). (H-O) LoG filtered (ImageJ, D. Sage).

FIG. 2A-2B. Dwell times of β-actin mRNA at the NPC. mRNA co-localized with NPCs, no. frames as milliseconds. Histogram=observed mRNAs per time bin of 20 ms. (A) Fit of dwell time of cumulative trace length distribution [23] (black circles). First bin =total number of observed traces. Fast transport events (<0.8 s) show monoexponential decay (black circles). Dwell time=172±3 ms, (grey line, first component black line). Second time constant=2000±120 ms is needed to fit complete data set (black line). mRNA in the nucleoplasm (grey line), dwell time=15±1 ms (90%) and 104±6 ms (10%). Data normalized. (B) Data from (A) (black circles) replotted as trace duration histogram (black bars). Cut-off (adjacent averaging width=5 bins). Inset=unprocessed raw data. Two-step convolution model (black line) reveals two kinetic rates [24], dwell times k_{fast}=43±1 ms and k_{slow}=139±10 ms. Identifying export=two observations=40 ms. Result consistent with multistep process containing at least two rate constants, total time=180 ms.

FIG. 3A-3C. ‘Binding Sites’ of mRNAs at Nuclear Pores. Distances between mRNA and POM121-tdT (zero position) bin widths=25 nm. (−)=cytoplasmic C, (+)=nucleoplasmic position N. Red lines are global fits, dark grey line is fit to cytoplasmic binding distribution, light grey line is fit to nucleoplasmic binding distribution. (A) Histogram of all observed transport events at NPCs (B+C). (B) Histogram for fast transported mRNAs (90% translocation). (C) Histogram for slow mRNAs, observed for extended times at NPC.

FIG. 4A-4B. NPC Topography of mRNA Export. Results from FIGS. 3B and 3C (hatched & open bars) plotted (A) to scale with known NPC dimensions (B) [3]. mRNA export timescale (black=k_{slow}; grey=k_{fast}) along NPC axis combined with single molecule data (grey bars) of Nup358 [23], import factors [25] and import release site [26]. Nuclear peak position of slow transporting mRNAs located between binding sites for import factors and import release site. Length of grey bars =FWHM of binding site distributions.

FIG. 5A-5F. Experimental Setup for Export Time. (A) A genetically altered mouse was derived whereby endogenous β-actin mRNA was labeled using the 24×MS2 stem loop cassette inserted into the 3′ UTR of the β-actin gene by homologous recombination in ES cells. MS2 coat proteins (MCP), fused to YFP, bind the RNA stem loops as dimers (inset) further multiplexing the label. (B) NPCs were labeled with POM121-tdTomato using viral infection of immortalized fibroblasts from the β-actin-24 MBS mouse. (C) Optical Setup. Light from a 514.5 nm and a 561 nm laser was delivered by a single mode fiber F and imaged to the specimen plane S by an objective O. An iris I is used to adjust excitation for the field of view. Two dichroic mirrors are used to separate excitation and emission signals DC and split red and green signals DC-1 towards two cameras CCD 1 and CCD2. A mirror M is used to reflect the light out of the microscope stand. Notch filters N are used to block scattered light from the lasers. A minimum number of lenses L is used to optimize detection efficiency by reducing the amount of surfaces in the light path. ‘Super-registration’ is achieved for each individual data set by post experimental determination of transition matrices between both channels based on nuclear pore signals imaged onto both cameras immediately prior to tracking data acquisition. Dichroic 1 (a z543rdc from Chroma) has a broadband anti-reflective coating. However, it is possible to image front- and back-surface reflections of that mirror on the highly sensitive cameras. (D) A laser beam (658 nm) was placed directly along the optical axis of the microscope and passed through DC-1. Low amounts of light are reflected onto CCD-1 (green channel). (E, F) Using excitation with only 561 nm light the same effect can be produced for nuclear pores labeled by POM121-tdTomato. These signals are used to ‘super-register’ the two CCD cameras.

FIG. 6. Example of setup to achieve super registration using a virtual fiducial marker. The key piece of the design is a Mask that has one or multiple openings through which light can travel. This way it can be used for either negative or positive contrast. This mask can either be transluminant or non-transluminate with or without additional structures being added to shape the intensity profile of the mask in the sample. The mask can also be a micro mirror array. This mask can be held in a translation stage that allows the mask to move in x and y directions with a step width small enough to allow sub-diffraction displacements of the image of the mask in the sample. Alternatively, an image of the mask can be moved by optical means to achieve displacement in the sample. An excitation source (Exc.) provides light. The light from that source is delivered by a first lens system (LS1) onto the mask. An image of the mask is projected into the sample acting as a virtual fiducial marker (VFM) by lens system 2 (LS2).

FIG. 7A-7F. Chromatic corrected Super-registration Approach. Using a dye that emits with a long tail up to the ˜700 nm range a cellular structure (here DNA) was stained. The dye is excitable at 405 nm. A) Emission of the dye in the green channel (527 to 555 nm detection with emission band pass). B) Emission of the dye in the red channel (570 to 620 nm detection with emission band pass). C) Overlay of A) & B) after preforming super-registration. The registration matrix was applied to register the images in D) & E). D) mRNA signals in the center plane of a mammalian cell nucleus, the green signal is coming from a YFP-MS2 tag on the mRNA. E) Nuclear Pores in the same image plane super-registered onto the mRNA signal. D) and E) are showing that the dye is not excited by 515 or 561 nm excitation and does not contribute background in the corresponding channels if not specifically excited. F) Overlay of D) and E) showing a few mRNAs located to nuclear pores, while the majority is roaming the nuclear volume.

### DETAILED DESCRIPTION OF THE INVENTION

The present invention provides a method of imaging molecules, the method comprising:

providing a multi channel marker that can be detected by multiple detection areas;

labeling one or more type of molecule with a fluorescent marker, wherein different types of molecules are labeled with spectrally distinguishable fluorescent markers;

spatially registering the multiple detection areas;

recording a registration signal from the multi channel marker on the multiple detection areas;

imaging the labeled molecules;

evaluating the registration signal to obtain a transformation matrix for each pair of detection areas; and

applying the transformation matrix to imaging data recorded on multiple detection areas to thereby image the molecules.

The method can optionally comprise, for example, synchronizing in time the multiple detection areas. This can be accomplished, for example, by generating a transistor-transistor logic pulse in one detection area and using it to trigger another detection area. As another example, multiple detection areas can be on one physical chip.

The multi channel marker can be provided, for example, by labeling one type of molecule with a fluorescent marker, wherein the marker is an inherent multi channel marker. The fluorescent marker that is an inherent multi channel marker can be, for example, tdTomato, mCherry, hcRed, tagRFP, Cy5, Atto647N or Cy3.

Alternatively, for example, the multi channel marker can be a virtual marker that is provided by projecting an external signal onto multiple detection areas.

The inherent multichannel markers have the following in common: a) they are bright (can emit a large number of photons), either by multiplexing of many emitters or by nature, and b) they can be excited alone, i.e., a light source can be used to only excite the multichannel marker but not the other labeled molecules. In case of the virtual multichannel marker the concept reduces to a) as the virtual marker can be generated in many colors either at the same time or sequentially and does not need to be fluorescent. This also means the virtual multichannel marker can be used on any microscope, such as a fluorescent microscope.

In different embodiments, one or more of the multiple detection areas can be one or more camera. One or more of the multiple detection areas can be, for example, one or more of a charge-coupled device (CCD), an electron multiplying (EM) charge-coupled device CCD, complementary metal oxide semiconductor (CMOS) or scientific CMOS (sCMOS) camera, or a Photon Multiplier Tube (PMT) or an Avalanche Photon Detector (APD) point detector. Multiple detection areas can be provided within one detection device. For example, multiple images can be focused on one camera [29]. However, a multiple camera solution may be superior for detection efficiency and achievable field of view.

Different lasers can be used to image different types of molecules labeled with different fluorescent markers. Alternatively, or in addition to lasers, fluorescence lamps combined with appropriate filter sets or tunable laser source, white light laser source, light emitting diodes (LED), for example, or other light sources that can generate a specific spectral band width suitable for fluorescence excitation can be used.

The method provides that high resolutions can be achieved, e.g., a registration distance between detection areas that is less than or equal to 50 nm, or less than or equal to 10 nm, or less than or equal to 1 nm.

The methods and apparatus of the present invention can be used, for example, to image molecules located within a living system, a transluminant sample or cell.

The beam path to multiple detection areas can optionally be aligned, using for example any or all of the following procedures.

1) Adjust the optical magnification by exchanging the tube lens according to the objective magnification. For example, with cameras that have 16 micron pixels, the optical magnification can be adjusted so that the pixel size in image space is between 64 nm and 120 nm. With a 150× objective that translates into 106.6 periodic nm pixel size in image space. In principle one can use smaller or larger values, e.g. 160 nm pixel size (done for instance using 100× objectives), but the pre-alignment precision is about half a pixel and so smaller pixels improve super-registration precision, while they reduce localization precision for signal detection. In the studies described below, the best results were obtained with a 250× magnification. Magnification can be adjusted by many different means (e.g., objective magnification, relay imaging system with magnification, and single lens magnification), but exchange of the tube lens is most light efficient if magnification is aimed for that cannot be provided by changing the objective, e.g. currently 150× objectives are the maximal magnification for objectives with high enough N.A.s. Numerical Apertures that are suitable for this kind of work will be between water immersion (N.A.=1.2) and special immersions (quartz glasses or others) that allow N.A.s of larger 1.5. Usually oil objectives with N.A.s of 1.4 to 1.49 or Glycerin/Silicon objectives with N.A.s between 1.3 and 1.4 will be chosen.

2) Align the tube lens centered and without tip or tilt on the optical axis of the objective. This can be done, e.g., using an alignment laser that is aligned onto the mechanical center axis of the microscope body. This is an approximation for the objectives optical axis.

3) Mount a secondary dichroic mirror so that incoming signal is split under 45 degrees, with the transmitted signal having no angular offset. A piece of glass like a dichroic results in a lateral shift of the image beam that is transmitted. This shift depends on the thickness of the glass. This is one reason why images from multiple detectors or detector regions need to be x,y shifted to overlay. This can be achieved by moving the cameras, but one could use optical elements in the beam path to achieve that effect, for instance compensation glass cubes or mirrors. Such elements do reduce the sensitivity of the detection. Angular offsets will result in a skewed detection of the incoming wave-front which leads to small changes in the focal position across the image. The 45 degree of the reflected signal are achieved by tip and tilt alignment of the dichroic mirror.

4) Install cameras so that they are centered on the optical axis and in the focal plane of the tube lens and orthogonal to the optical axis. This can be done by x,y and z alignment of the both cameras using micrometer stages and an optical rail along the optical axis. Targets can be mounted on the cameras c-mount, but there are alternative ways of alignment. The focal plane of the tube lens is estimated by its focal length and cameras are only roughly adjusted to this distance. It is possible to use an alignment laser to find the z-position with higher pre-accuracy.

5) Connect triggering and other cable to the cameras latest at this point as later mounting might interfere with the fine alignment.

6) Image a z-focus target simultaneously on both cameras with the individual camera signals being displayed each for itself Align z-position (along the optical axis) until both camera signals are identical. This can be verified by defocusing the objective. Verify z-positions of cameras with signals of the anticipated target wavelength. Z- alignment needs to be performed with the sample in the image plane of the objective. A change in the z-position of one camera relative to the other will result in small magnification differences. The z-focusing is less precise than x.y registration due to the reduced resolution of optical systems along the optical axis. For this reason ‘de-focusing’ can compensate for chromatic aberration within limits. Focal check beads and the Geller Standard were found to be most suitable for this application. From here on display sums (e.g., red green overlay) of the two or more images.

7) Use a resolution standard, sufficient for the optical system, to overlay the cameras in x,y and rotation around the optical axis. This can be, e.g., Multicolor beads or the Geller standard if the total magnification is large enough.

8) Measure the intensity profile of the excitation field. The profile is needed to analyze the result in step 9 below. Due to the Gaussian profile of the laser beam, emission signal in the center of the excitation beam will be brighter than at the edge. However, signal strength should behave symmetric and correlate with the excitation profile. If a tip or tilt of the detector relative to the optical axis exists, it will result in a change of detected signal across the field of view.

9) Use a homogenous one layer diffraction limited fluorescence sample to verify focal position over the field of view.

The image can be split, for example, behind the tube lens. Alternatively, the image can be split prior to the tube lens and then multiple tube lenses can be used to focus onto the detection areas (e.g., cameras).

Preferred excitation requirements: The excitation sources (e.g., laser) need to be spatially overlaid. On can use, e.g., a single mode fiber, but a spatial filter or a multiband excitation source (e.g. white light laser) could do the same. The source for exciting the fiducial marker needs to be setup in a way that it can be used alone or in combination with the other sources. The intensities of the excitations sources need to be fine-tunable. For example, in the experiments described below, the combination of fluorescent markers used (YFP and tdTomato) can show cross talk between detection channels if the emitted light intensity is high. As this would also shorten observation time and provide unnecessary stress/damage to the cell, it is absolutely necessary to fine tune the excitation intensity with better 50 microwatt resolution. Optimally a AOTF (Acusto-Optical Tunable Filter) is used, but data can be generated using, e.g., neutral density filters and mis-alignment of the single mode fiber for intensity adjustment. The sources need to be focused into the back focal plane of the objective, being fully overlaid.

Properties of fiducial marker: The fiducial marker needs to be made in a way that it can be detected in all channels that need to be super-registered. In experiments described below, td-Tomato was used to generate a strong enough signal so that the surface reflection of the image splitting dichroic mirror can be used in the green shifted channel.

Generate super registration signal: For example, directly before the experiment image only the fiducial marker of the cell used for data acquisition and detect the signal in multiple (e.g., both) channels. Preferably, it would be best to obtain the super-registration signal directly after imaging the molecules. With a virtual fiducial marker this would be possible.

Post experimental image super-registration: Use the fiducial marker image set to generate the highest possible quality single (projected) frame to identify four distributed fiducial markers in multiple (e.g., both) channel images. This is image processing, time projections can be used to reduce noise in the image, but other possibilities exist (e.g., longer integration). Project two channels onto each other using, e.g., a projective transformation. A simpler 3 point transformation might be sufficient if the holding mechanics for the cameras are improved, an algorithm using more pores can be used. Apply the transformation matrix from the previous step to the raw data sets of the experiment. In the experiments described herein below, the approach was to transform the tdTomato pores into the space of the mRNA. It will depend on the amount and quality of the fiducial marker signal in which direction to apply the transformation.

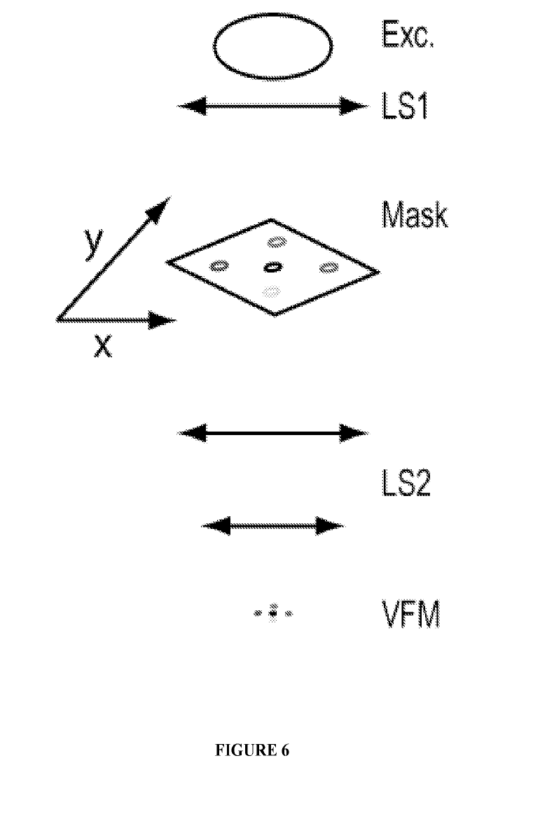

Setup to achieve super registration using a virtual fiducial marker: Super registration was achieved in experiments described below by using a fiducial marker that is located inside the cell and provides a registration signal for all detection areas in question. However, fiducial markers can be generated in any transparent sample virtually by means of imaging a suitable reference signal into the sample. This design allows for a device that can be attached to any microscope to achieve super registration between multiple spectrally resolved images. This device also holds potential application for 3D super registration, as the virtual fiducial marker can be focused along the optical axis of the microscope to multiple z-planes within the sample. An example of the design is detailed in FIG. 6. The key piece of the design is a Mask that has one or multiple openings through which light can travel. This mask can be held, for example, in a translation stage that allows movement of the mask in x and y directions with a step width small enough to allow sub-diffraction displacements of the image of the mask in the sample. Alternatively, an image of the mask can be moved by optical means to achieve displacement in the sample. An excitation source (Exc.) provides light with the spectral properties needed. This can be achieved, for example, either with a broad spectrum source or multiple spectrally resolved light sources, e.g. diodes. The light from that source is delivered by a first lens system (LS1) onto the mask. This can be, e.g., Kohler illumination or other illumination geometries. If needed one or more band pass filter can be part of LS1. An image of the mask is projected into the sample acting as a virtual fiducial marker (VFM) by lens system 2 (LS2). Lens system 2 will have best possible color correction to minimize aberration effects on the super registration signal.

General comments: The individual signals of the virtual fiducial marker (vfm) need to be separated to allow no-overlap in the detection. The size of the individual vfm signals can either be diffraction limited or not. Super registration precision is based on the localization precision of the individual vfm signals. Those precisions are normally better for larger signals, providing they have a sufficient gradient. Incremental displacement of the vfm allows creating any number of registration points in the sample that can be used to achieve super registration for the whole field of observation. The resolution between vfm positions is then given by the incremental step size of the translation stage holding the mask or the smallest incremental step size by which the vfm is moved in the sample by other means and the magnification of lens system 2. The total time needed for collection of registration signals from the vfm will be determined by the number of individual holes in the mask and the number of incremental steps needed to cover the distance between holes in the mask and the resolution request that is applied to determine the number of such individual steps. The signal intensity per vfm is a function of the excitation light source. Based on the very low signal available from the cell inherent fiducial marker the expectation is that each registration image can be taken within a millisecond time frame. The vfm can be projected into the sample directly after the data is acquired and hence can improve data quality compared to the sample inherent fiducial marker. This is because no bleaching occurs prior to data acquisition. The precision realized for spatial alignment of multiple detection areas can be tested by imaging diffraction limited structures that contain multiple label or have a wide spectral emission band.

The invention provides a virtual fiducial marker for imaging comprising: a mask containing one or more openings through which light can pass; a first lens system on one side of the mask to deliver light onto the mask; and a second lens system on the opposite side of the mask from the first lens system to project an image of the mask into a sample to be imaged, thereby acting as a virtual fiducial marker. The mask can be, e.g., held in a translation stage that allows movement of the mask in x and y directions. Alternatively, e.g., an image of the mask can be moved by optical means to achieve displacement in the sample.

The invention further provides a device for imaging molecules, the device comprising: any of the virtual fiducial markers disclosed herein; an excitation source that provides light to the first lens system; and multiple detection areas for recording imaging data from molecules labeled with fluorescent markers.

Molecules that can be imaged include, for example, DNA, RNA such as mRNA, peptides, and proteins, such as for example a nuclear core complex.

The invention provides methods and apparatus for imaging molecules substantially as described herein with reference to any one of the embodiments of the invention illustrated in the accompanying drawings and/or described in the examples.

### Experimental Details

### Introduction:

The present invention is exemplified by studies that characterized the kinetics of nuclear export of mRNA via the nuclear pore complex (NPC), which is located within the nuclear envelope of eukaryotic cells. Single fluorescent endogenous β-actin mRNAs were tracked through labeled individual nuclear pores in living cells. β-actin mRNA was labeled with yellow fluorescent protein (YFP) fused to a MS2-protein tag. The NPC component POM121 was labeled with tandem Tomato.

### Methods Summary:

An immortalized cell line was generated from a homozygous mouse carrying the MS2 stem-loop cassette in the endogenous β-actin gene so that all β-actin mRNA were labelled by a genetically expressed fluorescent YFP—MS2 tag. This cell line was modified to express the NPC marker POM121—tandem Tomato, allowing for simultaneous imaging. The cell line showed no growth defects. To visualize NPCs and mRNA with sufficient time resolution (50 Hz frame rates) and field of view (21.5 μm diameter) two electron multiplying (EM) charge-coupled device (CCD) cameras were used. For magnification adjustment, fine-tuning of excitation energies and illumination field, maximal light transition and enabling of precise mechanical pre-alignment of the two cameras, a microscope was set up based on an IX71 microscope stand (Olympus) using a 1.45 N.A. 150× oil objective lens. All other components were replaced with custom parts. Synchronization (nanosecond timescale) of the cameras was achieved by triggering one camera to a TTL pulse generated by the other camera. Super-registration uses an inherent dual channel marker, here the high signal state of POM121—tdTomato. Before data acquisition, the emission signal and the surface reflection of the splitting dichroic mirror are imaged in both channels at the same time. These pore signals are used to register images post-experiment, taking into account inhomogeneities of cover glass thickness and aberrations attributed to optical distortions in living cells.

### Setup ‘for Super-Registration’ Microscopy:

‘Super-registration’ refers to the ability to generate an internal registration signal from the sample, e.g. each cell imaged, that can be used to register spectrally different channels relative to each other to achieve spatial precision below the optical resolution limit. Image series were acquired on a customized dual channel setup (FIG. 5C) using an Olympus 150× 1.45 N.A. oil immersion objective lens. The right side port of an IX71 (Olympus) was modified by removing the tube lens. Outside of the stand was placed a 514.5 nm notch filter (Semrock), a 300 mm focal length lens, followed by a 568 nm notch filter (Semrock) that was rotated by 17 degrees to the normal to achieve blocking of 561 nm scattered light. The effective magnification of the optical system was 250x resulting in a pixel size of 64 nm. A dichroic mirror (z543rdc, Chroma) was used to split the fluorescence onto two EMCCDs (Andor iXon, Model DU897 BI). A combination of mirrors and CCD supports (x,y,z, φ- and θ-angle) was used to physically pre-align both CCDs to optimize ‘superregistration’ after image processing. A resolution standard (Gellermicro), focal check beads (Invitrogen) and diffraction limited multi-color beads (Invitrogen) were used for pre-alignment. Using two cameras it is possible to adjust their focal planes independently to account for small axial chromatic shifts. This is an improvement over “dual-view” systems where the chip is shared with two images. Super-registration is achieved by combination of precise mechanical alignment and image processing using transformations based on the registration signal that is detected on both cameras. CCDs were synchronized by a start signal generated by one CCD that was directly delivered to the second CCD. The offset between the two CCDs was determined to be three orders of magnitude below the integration time (2.1±0.2 ns/frame/ms). For excitation of fluorescent proteins an Argon laser with 514.5 nm emission (Melles Griot) and a 561 nm laser line (Cobolt) were merged into a mono mode optical fiber (Qioptiq). The output of the fiber was collimated and delivered through the back port of the IX71 stand and reflected towards the objective by a dichroic mirror (z514-561-1064rpc, Chroma). Alignment onto the optical axis of the objective was achieved with a 4-axis controlled support for the collimator. An adjustable size iris was used to restrict the illumination to an area of approximately 25 μm in diameter. The intensity profile in this area had a flatness of about 5%. Each laser had a shutter (Uniblitz) that was controlled from the imaging software. To allow reasonably fast switching (100 ms) between high and low power settings with the 561 nm line, a motorized filter wheel with appropriate neutral density filters was placed behind the shutter but before the merging dichroic of the laser module. The microscope was equipped with a heated stage inset (Warner Scientific) and an objective heater (Bioptechs). During the experiment the stage was covered by a 100 mm cell culture dish wrapped with aluminum foil to exclude stray light. Heating devices were run overnight before an experiment. One hour prior to an experiment three small dishes with a few ml of water were placed on the stage inset to provide humidity. Cells were imaged in a closed dish.

### Image Acquisition:

Simultaneous imaging of nuclear pores and mRNA enabled a relative measurement of distances (drifts are accounted for by the tracking of both entities) and hence overcomes a limitation in earlier work on imaging nucleocytoplasmic transport, namely missing information on the exact position of the nearest nuclear pore during the acquisition of the cargo signal. To achieve this goal with both sufficient spatial and temporal resolution EMCCDs, laser shutters and the filter wheel were controlled from the camera software using customized scripts written in Andor Basic. Using sub-frames (˜⅔ of each chip, 330×330 pixel) on both cameras whole nuclei were observed at a frame rate of 50 Hz equaling a time resolution of 20 ms for tracking single mRNAs. The effective integration time was 19.92 ms. A frame rate of 20 ms was chosen to gain sufficient tracking resolution. Test experiments at 50 ms frame rates showed blurring of mRNA signals while 20 ms frame rates offered adequate signal accumulation to “freeze” the RNAs with a positional accuracy sufficient for tracking. To generate the ‘super-registration’ signal used for post experimental, computational fine alignment of the two detectors the following imaging protocol was implemented. Potential cells of interest were selected and brought into focus (equatorial plane) at very low power settings (0.5 W/cm⁻²) in the red channel using maximal gain on the camera, by avoiding excitation at 514.5 nm bleaching in the green channel was minimized. Next, an automated protocol was used to image NPCs only at 561 nm laser using ‘high’ power setting (180 W/cm⁻²) for 50 frames, followed by a 100 ms break to save data, switch gain settings and filter wheel position, followed by 400 frames with both laser lines (514.5 nm used at 15W/cm⁻², 561 nm used at 18 W/cm⁻²). While the green channel CCD was used with 1000× gain during both imaging cycles, the gain on the red channel CCD was adjusted between 450 for the first cycle and 1000× for the second cycle. The first imaging cycle generated a detectable signal from the NPC staining on both cameras, due to surface reflection on the dichroic mirror between the cameras. The front surface reflection was more pronounced than the back surface reflection and could be detected well enough to use an average time projection of the 50 images collected in the first imaging cycle as a reference for image alignment (FIG. 5). Power measurements were done using an objective power meter (Carpe). Stage drifts during data acquisition were minimal and as the nuclear pores and the mRNA were imaged simultaneously no extrinsic drift control was needed.

### Image Processing:

The image information of the mRNA and NPC signals needed to be fine registered post experimentally. For each cell imaged, two data sets per channel were collected as described. The first set contained signal from the nuclear pore label, POM121-tdT, which was recorded on both cameras. Time projection of the average signal yielded an image that identified single NPCs. Original image stacks were divided into two sub-stacks with only half the area but still retained the same number of images to achieve better registration because of non-monotonic distortion over the field of view. Time projected images from both cameras were registered using ‘projective’ transformation in MatLab. The individual transformation matrixes were applied to the second movie from the red channel of each data set to overlay NPCs with the mRNA signal. The signal of the NPC label in the second movie was much lower due to bleaching during the recording of the registration data. To improve the signal-to-noise ratio a sliding average of 15-25 frames was calculated for the second movie and used to fit the NPC positions during the experiment. This averaging resulted in a reduced time resolution for the NPC signal. As nuclear pores are relatively immobile at least 6 nuclear pores per cell from 15 different cells were tracked for at least 150 frames in these averaged movies to estimate the localization precision of the nuclear pore signal. Based on the mean error of the localized position of these NPCs, 15 nm localization precision was achieved. This value is an underestimation, as cellular movement will contribute to the error source for localization over this time range. The drift of an average NPC was 1.1±0.2 nm between subsequent frames (20 ms integration time).

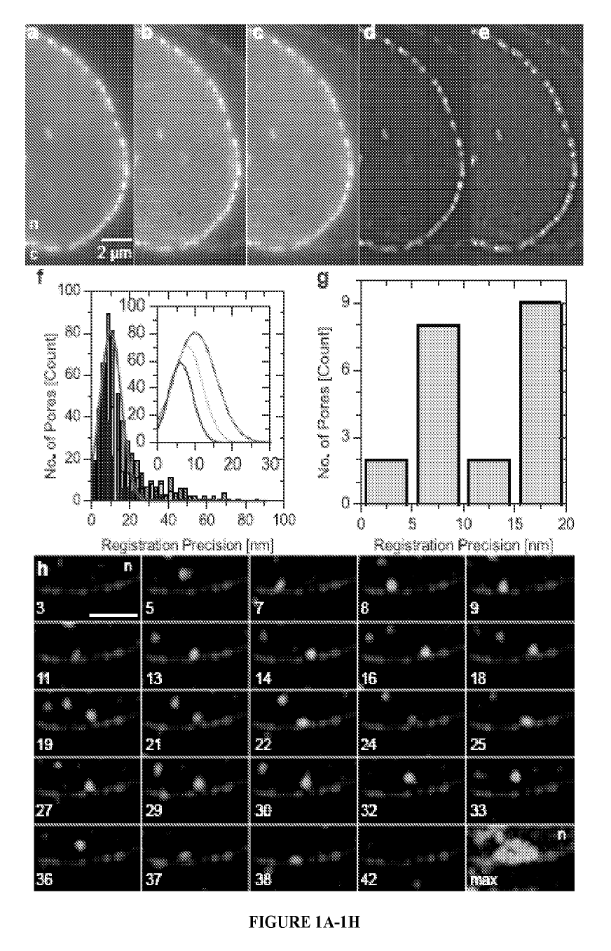

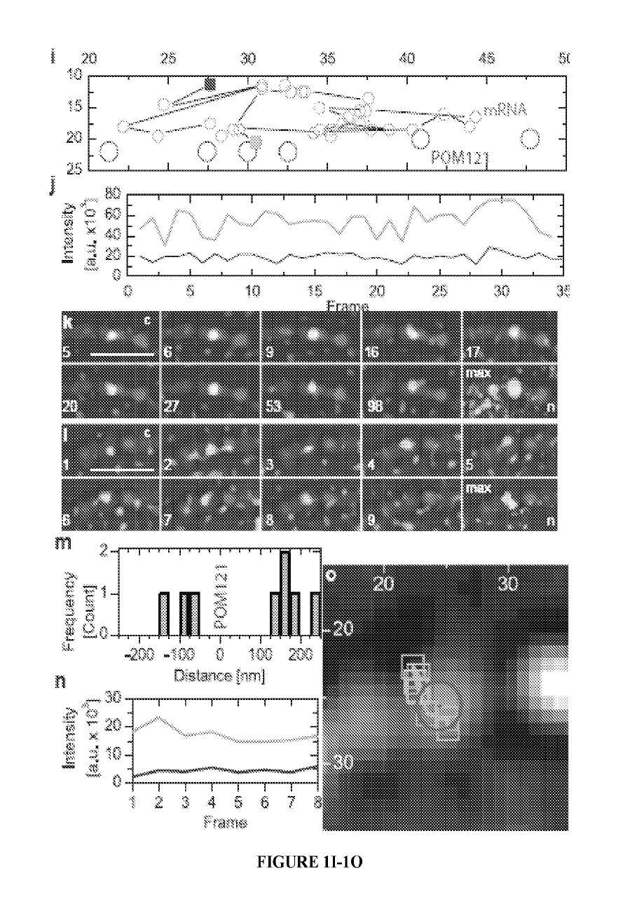

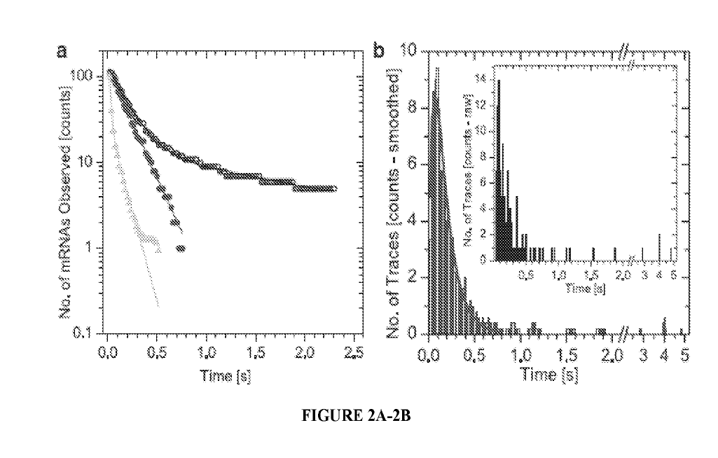

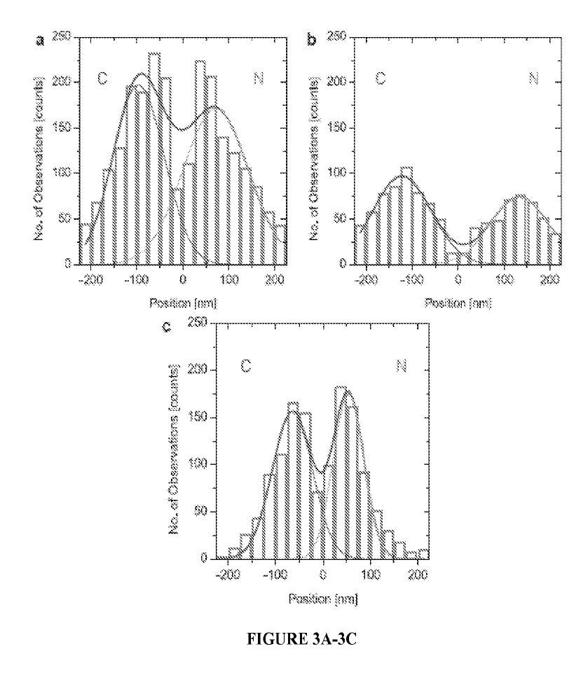

The image registration precision was tested by fitting NPC positions on the green channel registration data set and the registered red channel data set for nine cells. The resulting registration precision was better than 10 nm (FIG. 1). Determination of the absolute colocalization precision in living cells by this method is limited by the available signal in the green channel. As photons contributing to this image are reflected off the glass surface of a dichroic that is designed to transmit light at this wavelength the signal-to-noise ratio in the green channel is clearly worse than in the red channel. Compensation could be reached by longer imaging at high laser intensities, but at the cost of losing the capability to track nuclear pores during acquisition of export movies in the green channel. The applied transformation matrix is based on four pores that have been identified in both images. Hence, co-registration precision was tested by calculating the distances between 6, 10 and 15 nuclear pores in both images for a total of 21 registered nuclei from two of three experimental sets (a total of 33 cells) (FIG. 1). Each registered image series contained an expected number of 40 to 60 nuclear pores, depending on the size of the nucleus. Based on the differences in signal-to-noise ratio between the two registration images, 10 nuclear pores are a fair sub-sample to estimate registration precision, leading to a registration precision of 8±1 nm. Six pores might be too few as the number is almost identical with the number of pores used for super-registration, while 20 pores would introduce a co-registration uncertainty that would be largely determined by the signal-to-noise ratio of nuclear pores imaged in the green channel. The resulting registration precision is 10±1 nm if a 15 pore criterion is applied (FIG. 1). NPC and mRNA signals were evaluated by Gaussian fitting. While the localization precision for nuclear pores could be determined experimentally within the data sets to be 15 nm, the localization precision for the mRNA signal was estimated from the number of detected photons and the FWHM of the Gaussian fit by Equation 1 [1]:

$${Loc}_{precision} = \sqrt{\frac{{s}^{2} + ( {a}^{2} / 12 )}{N} + \frac{8 π {s}^{4} {b}^{2}}{{a}^{2} {N}^{2}}} .$$

The number of photons (N) was calculated from the counts detected by the camera and reported by the fitting routine using the manufacturer's calibration data for each camera, taking into account the electron multiplying gain, electrons generated per A/D count, quantum efficiency of the CCD and the energy of a photon at the center emission wavelength. The factor ‘s’ is the standard deviation of the Gaussian approximation of the point-spread function. It is determined by fitting a steady signal repeatedly and calculating the distances between identical positions in different frames. The mRNA is moving and hence this value must be estimated for use in Equation 1. One consequence of an inherent mobility of the signal is that it will spread and be less bright than an immobilized equally labeled sample. The following assumptions were used: a signal that can be fitted has to have one brightest pixel. The brightest pixel will be a lower approximation for the true position of the mRNA. Hence ‘s’ can be approximated as ‘a.’ The pixel size ‘a’ was 64 nm, and the background b was estimated from the data sets. The resulting localization precision for the mRNA signal was 19 nm. The colocalization precision between NPC and mRNA signal is given by Equation 2:

$${CoLoc}_{precision} = \sqrt{{σ}_{registration}^{2} + {σ}_{{mRNA}_{precision}}^{2} + {σ}_{{NPC}_{precision}}^{2}} .$$

The precision of mRNA signal is σmRNA=19 nm, nuclear pores are localized with 94 NPC=15 nm and the registration between the channels is σregistration=10 nm. The overall colocalization precision that equals the achieved ‘super-registration’ is calculated to be 26 nm. All the numbers for registration precision between cameras, localization of mRNAs and nuclear pores are the average of the data. While such an average is a reliable and well defined measure, such a number might be of limited relevance for the biological problem. In detail, the observed kinetics of transient interactions in living cells would be heavily biased if traces would be cut short because in individual frames during the total interaction time the signal of one of the observed entities drops below the threshold value for registration precision. Accordingly, selection of data points based on the localization precision, as used in single molecule based super resolution techniques, is not an option for tracking in living cells. The data presented here present a break-through in spectrally resolved super-registration microscopy as they are mostly limited by the detection precision of the mRNA signal, not the pore signal or the channel registration precision. Gaussian fits were preformed with two routines. One routine included automated particle identification and nearest neighbor tracking as described by Thompson et al. [27]. The other routine was analogous to Kubitscheck et al. [28] but implemented in a semi-automated way. Upon ‘clicking’ of a signal the brightest spot in a ten pixel environment is found and a center of mass algorithm delivers the start point for the Gaussian fit. A number of control checks was used to validate the fit. All fit parameters are immediately reported to the user to allow direct appreciation of the fit. A graphical help was also implemented to disallow for confusion of particles. This routine was used to fit all signals within a 10-15 pixel distance of the nuclear envelope. This allowed visual identification of signals and manual tracking. As the focal thickness of the observation volume was small, due to the high N.A. of the objective, manual tracking allowed better control of ‘blinking’ events. Both routines used raw data to perform the fitting. Localization precisions are based on fits performed according to Thompson et al. [27].

### Cells:

Immortalized Mouse Embryo Fibroblast cells (MEFs) from a homogeneous transgenic knock-in mouse for β-actin-24-MBS were infected with a lentivirus coding for NLS-MCP-YFP protein. The mouse develops normally having all β-actin transcripts tagged with the 24× MBS repeats. This stable cell line was FACS sorted for low expression levels of NLS-MCP-YFP and infected with a lentivirus coding for POM121-tandem-Tomato (POM121-tdT). Cells were FACS sorted for double positive signals in the green and red channels. Successive FACS analysis was used to separate cells with homogeneous NLSMCP-YFP and POM121-tdT expression. Growth curves of the immortalized MEFs, MEFs derived from the β-actin 24 MBS mouse, β-actin MEFs with either NLS-MCP-YFP or MCP-GFP expression and β-actin MEFs with additional POM121-tdT expression were collected. Cells were seeded at 3000 cells/ml density in 60 mm dishes. A total of 30 dishes for each cell line were seeded and up to four dishes a day were harvested and counted. A hemacytometer (Fisher) was used for counting and at least four samples from each dish were counted. All five cell lines grew with the same doubling times, suggesting that neither the MCP label for the RNA nor the POM121 label for the NPC have major effects on cellular metabolism.

Cells were grown in DMEM (Cellgro, Mediatech) containing 10% FBS (Sigma) under 5% CO2 atmosphere. 24-36 hours prior to imaging, cells were split into glass bottom dishes (MatTek). Shortly before imaging, cells were washed with PBS (Sigma) and transferred into DMEM without Phenol Red, containing 10% FBS and 25 mM HEPES (Gibco). Each dish was imaged at 37° C. for less than 60 min.

### Results and Discussion:

A stable cell line was generated, derived from a transgenic mouse, where all β-actin mRNA is labeled by yellow fluorescent protein (YFP) fused to a MS2-protein tag [5, 6] (FIG. 5). β-actin mRNA is an essential gene with an estimated size of less than 25 nm, being diffraction limited even if the MS2 sequence should be extended. To ensure sufficient labeling of mRNAs at low expression levels of MS2-protein, the tag was enriched in the nucleus by adding a nuclear localization signal which does not interfere with mRNA export. To allow simultaneous imaging of mRNAs and NPCs, POM121 was labeled with tandem Tomato (FIG. 5). POM121 exists in at least eight copies per NPC and is part of the NPC scaffold [7, 8]. Using a high numerical aperture objective, single NPCs in the equatorial plane of the nucleus were resolved and showed a distribution of the number of labeled POM121 per NPC. Simultaneous high speed movies of NPCs and mRNAs were taken using their distinct fluorescence tags on two precisely registered cameras (FIGS. 1, 5C). Rapid imaging was possible because amplification of the transcribed MS2 motif led to excellent signal-to-noise ratios for mRNAs (FIG. 1), even in cells expressing only low levels of the MS2-YFP tag (FIG. 1). It was found that mRNA export events for an individual pore occurred infrequently, beneficial for single molecule observations. An immediate observation was that mRNAs scan multiple pores (FIG. 1H). Together with a frequency analysis of mRNA-NPC interactions, it was concluded that not all pores are equally active in mRNA export at any given time. Because β-actin mRNA represents ˜0.1% of all molecules passing through NPCs during this time, possibly pore scanning represents a waiting phenomenon. To obtain the spatial precision capable of locating the mRNA relative to NPC dimensions, a method for super-registration of the detection channels below the diffraction limit was developed by registering two cameras within 10 nm (FIGS. 1F, 1G). The fluorescence of POM121-tdTomato was used to acquire inherent dual channel registration markers for each cell imaged.

Dwell times of mRNAs interacting with NPCs were observed (FIG. 1) compared to those in an equivalent observation volume in the nucleoplasm. Kinetics were much faster for nucleoplasmic diffusion (τ=15±1 ms) than for NPC interaction (τ=172±3 ms) (FIG. 2A). During transport, mRNAs were co-registered with NPCs for durations of milliseconds to seconds (FIG. 2). Dwell times at the NPC showed bi-exponential decay kinetics (FIG. 2A). 10% of slow events could be segmented from the total dwell time distribution using a threshold of 800 ms (FIG. 2B), whereupon the decay plot became mono-exponential (FIG. 2A). This indicated that the biexponential dwell time distribution resulted from two transport species rather than from two kinetic steps in the transport process. The trace duration histogram showed an initial increase followed by a decrease of observed traces per time bin (FIG. 2B) indicating that the fast transport process was a convolution of at least two kinetic steps. The data was fit to y=A(e^{(k}^{₂}^{x)}−e^{(k}^{₁}^{x)}) with k1 and k2 being rate constants (FIG. 2B) indicating that the observed co-registration of mRNAs with NPCs contains two or more rate-limiting transitions (FIG. 2) [9].

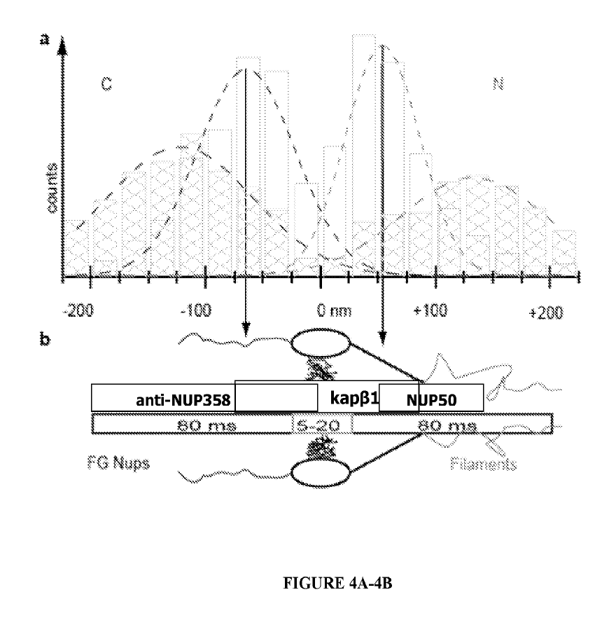

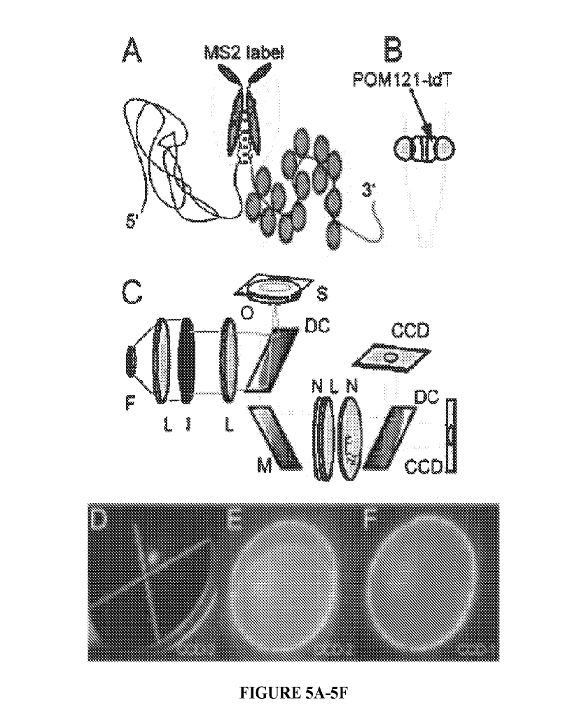

Export events were identified by identifying nucleoplasmic (+) or cytoplasmic (−) locations of mRNAs. A change in sign indicated a transport event within a trace. 765 traces were observed within 225 nm of a NPC, many showing mRNAs traveling along the nuclear border without engaging nuclear pores. 115 transport traces were identified, containing more than 2300 positional mRNA observations in 33 cells. This translates into a transport efficiency of 15% for this class of mRNAs. Transport traces that showed slow exporting mRNAs contributed ˜60% of the positional data. Three transport traces showed import of mRNA and 46 traces (40%) showed more than one directional change supporting the principle of reversibility of the translocation step through the central channel [10, 11]. Transport traces were further analyzed by calculating the distance between each observed mRNA position and the closest NPC (FIG. 3A). The resultant ‘binding site’ histograms displayed symmetric distributions with peaks on both pore surfaces. Faster exporting mRNAs (FIG. 3B) showed broader binding peaks than slower transporting mRNAs (FIG. 3C) and both were rarely observed within the central channel, arguing for a translocation time below the imaging rate. Within the 50 nm central channel (±25 nm from the POM121-tdT), fast transporting mRNAs accounted for 2.5%, while slow transporting mRNAs accounted for 12.8% of the observations contained in the binding site histograms (FIGS. 3B, 3C). Observation frequencies of mRNA can be linearly correlated to the transit time at any given point along the NPC axis, resulting in transit times of 4.25 ms across the central channel for faster mRNAs. Slower exporting mRNAs might not be interpreted in this manner due to multiple back and forth movements through the pore. The similarity of the binding site distributions for fast and slow transiting mRNAs emphasizes that functional interaction sites exist in the NPC outside of the core structure and central channel. Binding to the cytoplasmic or nuclear surfaces of the NPC accounted for the majority of observations of transporting mRNAs (FIG. 3). The kinetic analyses gave a total transport time of ˜180 ms (FIG. 2). The binding site analysis combined with the channel translocation time argues for a three-step transport mechanism that involves nucleoplasmic docking (˜80 ms), a fast translocation through the central channel (5-20 ms) and a cytoplasmic release step (˜80 ms) (FIG. 4). The symmetry in the nuclear and cytoplasmic binding frequencies argues for similar kinetics on both sides of the pore.

The widths of the binding sites were in the range of ˜60 nm. The combined cytoplasmic positions from fast and slow mRNAs led to a narrower width of the fit but on the nuclear side, the width of the combined datasets broadens (FIG. 3A). This could be interpreted as the existence of one narrow release site on the cytoplasmic surface of the NPC, but a larger target for mRNA binding on the nuclear face. The binding site for slow transporting mRNAs is located closer to the central channel (proximal) than for fast transporting mRNAs (distal). This could be consistent with this inner binding site functioning as a checkpoint, e.g. resembling the Nup98/Gle1 interaction with TAP or CRM1 [12, 13]. The cytoplasmic peak could be related as a release step, e.g. triggered by DBP5 as suggested by structural data [14]. Fast transporting mRNAs showed interactions outside of the NPC structure (FIG. 4). These locations may be coincident with nuclear filaments of the NPC (described in EM studies [15, 16]) and cytoplasmic Nup proteins [1, 17, 18]. While export of most mRNAs is mediated by the Tap/p15 transport factor complex and is independent of Ran-GTP levels, it depends on available ATP in the cell [14]. Short term energy depletion assays led to the observation of a narrow peak at 79 nm on the nucleoplasmic side of the pore and resulted in an extended dwell time for exporting cargo arguing for an energy dependent step in transport outside the central channel.

Several models for providing selectivity in nucleocytoplasmic transport have been described [2, 24, 25]. It has been proposed that a channelling effect, called ‘reduction in dimensionality’ results in a fast transport across the pore, once the cargo gains access to the central channel [21]. Regarding the translocation step, the existing models either formulate the central channel as the major barrier and ‘de facto sorter’ (selective phase model) or an entropic gate made of disordered phenylalanine and gylcine rich filaments that is overcome by receptor mediated binding to the pore (virtual gating hypothesis) [2, 4].

Using the present invention, the interaction of single cargos and pores were followed during export and individual transient steps of the export process and their rate constants were resolved, which were previously undefined. Despite the large size of the fully packed mRNA protein complex (mRNP), the transport time through the central channel is surprisingly fast (˜5-20 ms). The 1D diffusion coefficient was calculated for a 5 ms transport time through the central channel to be 0.5 μm²/s, which is in the lower range of mobility found for the mRNPs in the nucleus. Extrapolation of on rates of cargos using artificial nucleoporin gels predicts longer dwell times for the transit step but is limited by missing off rates [4]. A model where the central channel does not impose a rate-limiting step is favored. The data demonstrate that the major interaction sites are located at the NPC surfaces rather than within the central channel. Therefore the rate limiting step for mRNA transport is not the transition through the central channel, but rather access to and release from the NPC (FIG. 4).

Three advances have made these observations possible. First, labelled endogenous mRNA molecules (modified with the MS2 tag) were observed in their undisturbed native environment, forgoing the usual caveats concerning reporter genes that, in most cases, are over-expressed and non-physiological. Second, an internal reference based “super-registration” allows studying events that regulate mRNA transport in real time in living cells on length scales below the diffraction limit. “Super-registration” is to be distinguished from super-resolution where a large photon flux is used to describe the exact position of an emitting molecule. In contrast, the present approach registers two spectral sources of photons with sub-diffraction precision relative to each other by utilizing marker signals that pass through the same optical path used to collect the single molecule data. Importantly, this protocol is designed for use in vivo, minimizing photo damage using light fluxes of only a few hundred μW total input power. Finally, combining sensitive high-speed cameras with high signal-to-noise labelling methods, observations can be made with a time resolution of 20 ms. This approach is likely to be applicable to other cellular structures, such as DNA “factories”, interaction of nuclear RNA in “speckles” or Cajal bodies or mRNA degradation in “P-bodies” [24]. The classical use of colocalization in fluorescence microscopy suffers from possible misinterpretations concerning the actual proximity of components due to intrinsic errors in registration. The method of “super-registration” described here provides an order of magnitude greater resolution and hence a more rigorous criterion for the interaction of any two spectrally distinguishable components at the molecular level.

### FURTHER EXAMPLES

This example illustrates that super-registration can be extended to other than Nuclear Pore Complex labels and that an unequivocal, inherent chromatic correction can be achieved. Nano-vesicles or other targeted signal carriers, e.g. labeled cell permeable peptides or labeled recombinant protein dyes with suitable properties (emission range, quantum yield, selective excitation), can be used as a general marker for super-registration microscopy.

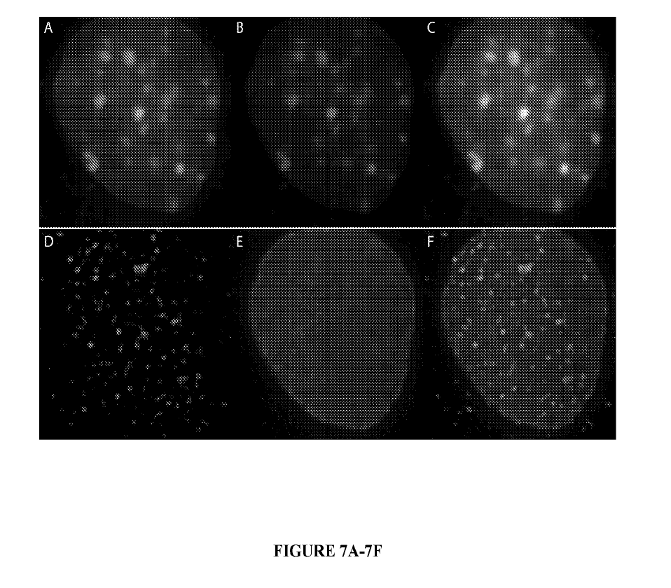

FIG. 7 provides an example of the chromatic corrected Super-registration Approach. Using a dye (Vybrant Blue) that emits with a long tail up to the ˜700 nm range, a cellular structure (here DNA) was stained. The dye is excitable at 405 nm. FIG. 7A shows emission of the dye in the green channel (527 to 555 nm detection with emission band pass). FIG. 7B shows emission of the dye in the red channel (570 to 620 nm detection with emission band pass). FIG. 7C shows the overlay of A) & B) after preforming super-registration. The registration matrix was applied to register the images in D) & E). FIG. 7D shows mRNA signals in the center plane of a mammalian cell nucleus; the green signal is coming from a YFP-MS2 tag on the mRNA. FIG. 7E shows Nuclear Pores in the same image plane super-registered onto the mRNA signal. D) and E) are showing that the dye is not excited by 515 or 561 nm excitation and does not contribute background in the corresponding channels if not specifically excited. FIG. 7F is an overlay of D) and E) showing a few mRNAs located to nuclear pores, while the majority is roaming the nuclear volume.

### REFERENCES

1. Stoffler, D. et al., Cryo-electron tomography provides novel insights into nuclear pore architecture: Implications for nucleocytoplasmic transport. J. Mol. Biol. 328 (1), 119-130 (2003).
2. Rout, M. P. et al., The yeast nuclear pore complex: Composition, architecture, and transport mechanism. J. Cell Biol. 148 (4), 635-651 (2000).
3. Beck, M. et al., Nuclear pore complex structure and dynamics revealed by cryoelectron tomography. Science 306 (5700), 1387-1390 (2004).
4. Frey, S. & Gorlich, D., A saturated FG-repeat hydrogel can reproduce the permeability properties of nuclear pore complexes. Cell 130 (3), 512-523 (2007).
5. Stockley, P. G. et al., Probing sequence-specific RNA recognition by the bacteriophage MS2 coat protein. Nucleic Acids Res 23 (13), 2512-2518 (1995).
6. Fusco, D. et al., Single mRNA molecules demonstrate probabilistic movement in living mammalian cells. Current Biology 13 (2), 161-167 (2003).
7. Hallberg, E., Wozniak, R. W., & Blobel, G., An integral membrane protein of the pore membrane domain of the nuclear envelope contains a nucleoporin-like region. J Cell Biol 122 (3), 513-521 (1993).
8. Cronshaw, J. A., Krutchinsky, A. N., Zhang, W. Z., Chait, B. T., & Matunis, M. J., Proteomic analysis of the mammalian nuclear pore complex. J. Cell Biol. 158 (5), 915-927 (2002).
9. Yildiz, A. et al., Myosin V walks hand-over-hand: single fluorophore imaging with 1.5-nm localization. Science 300 (5628), 2061-2065 (2003).
10. Nachury, M. V. & Weis, K., The direction of transport through the nuclear pore can be inverted. Proc Natl Acad Sci USA 96 (17), 9622-9627 (1999).
11. Kopito, R. B. & Elbaum, M., Reversibility in nucleocytoplasmic transport. Proc Natl Acad Sci USA 104 (31), 12743-12748 (2007).
12. Bachi, A. et al., The C-terminal domain of TAP interacts with the nuclear pore complex and promotes export of specific CTE-bearing RNA substrates. Rna 6 (1), 136-158 (2000).
13. Chakraborty, P., Satterly, N., & Fontoura, B. M., Nuclear export assays for poly(A) RNAs. Methods 39 (4), 363-369 (2006).
14. Carmody, S. R. & Wente, S. R., mRNA nuclear export at a glance. J Cell Sci 122 (12), 1933-1937 (2009).
15. Franke, W. W. & Scheer, U., The ultrastructure of the nuclear envelope of amphibian oocytes: a reinvestigation. II. The immature oocyte and dynamic aspects. J Ultrastruct Res 30 (3), 317-327 (1970).
16. Franke, W. W. & Scheer, U., The ultrastructure of the nuclear envelope of amphibian oocytes: a reinvestigation. I. The mature oocyte. J Ultrastruct Res 30 (3), 288-316 (1970).
17. Bastos, R., Pante, N., & Burke, B., Nuclear pore complex proteins. Int Rev Cytol 162B, 257-302 (1995).
18. Cordes, V. C., Reidenbach, S., Rackwitz, H. R., & Franke, W. W., Identification of protein p270/Tpr as a constitutive component of the nuclear pore complex-attached intranuclear filaments. J Cell Biol 136 (3), 515-529 (1997).
19. Ribbeck, K. & Gorlich, D., Kinetic analysis of translocation through nuclear pore complexes. EMBO J 20 (6), 1320-1330 (2001).
20. Macara, I. G., Transport into and out of the nucleus. Microbiol Mol Biol Rev 65 (4), 570-594, table of contents (2001).
21. Peters, R., Translocation through the nuclear pore complex: selectivity and speed by reduction-of-dimensionality. Traffic 6 (5), 421-427 (2005).
22. Lamond, A. I. & Spector, D. L., Nuclear speckles: a model for nuclear organelles. Nat Rev Mol Cell Biol 4 (8), 605-612 (2003).
23. Kubitscheck, U. et al., Nuclear transport of single molecules: dwell times at the nuclear pore complex. J Cell Biol 168 (2), 233-243 (2005).
24. Clemen, A. E. et al., Force-dependent stepping kinetics of myosin-V. Biophys J 88 (6), 4402-4410 (2005).
25. Dange, T., Grunwald, D., Grunwald, A., Peters, R., & Kubitscheck, U., Autonomy and robustness of translocation through the nuclear pore complex: a single-molecule study. J Cell Biol 183 (1), 77-86 (2008).
26. Sun, C., Yang, W., Tu, L. C., & Musser, S. M., Single-molecule measurements of importin alpha/cargo complex dissociation at the nuclear pore. Proc Natl Acad Sci USA 105 (25), 8613-8618 (2008).
27. Thompson, R. E., Larson, D. R., & Webb, W. W., Precise nanometer localization analysis for individual fluorescent probes. Biophys J 82 (5), 2775-2783 (2002).
28. Kubitscheck, U. et al., Nuclear transport of single molecules: dwell times at the nuclear pore complex. J Cell Biol 168 (2), 233-243 (2005).
29. Churchman and Spudich (Churchman, L. S. a. S., J. A. (2008). Colocalization of Fluorescent Probes: Accurate and Precise Registration with Nanometer Resolution. Single molecule techniques: a laboratory manual. P. R. a. H. Selvin, T. Cold Spring Harbor, John Inglis, Cold Spring Harbor Press.

1. A method of imaging molecules, the method comprising:
providing a multi channel marker that can be detected by multiple detection areas;
labeling one or more type of molecule with a fluorescent marker, wherein different types of molecules are labeled with spectrally distinguishable fluorescent markers;
spatially registering the multiple detection areas;
recording a registration signal from the multi channel marker on the multiple detection areas;
imaging the labeled molecules;
evaluating the registration signal to obtain a transformation matrix for each pair of detection areas; and
applying the transformation matrix to imaging data recorded on multiple detection areas to thereby image the molecules.

2. The method of claim 1, comprising synchronizing in time the multiple detection areas.

3. The method of claim 2, wherein detection areas are synchronized by generating a transistor-transistor logic pulse in one detection area and using it to trigger another detection area.

4. The method of claim 1, wherein the multi channel marker is provided by labeling one type of molecule with a fluorescent marker, wherein the marker is an inherent multi channel marker.

5. The method of claim 4, wherein the fluorescent marker that is an inherent multi channel marker is selected from the group consisting of tdTomato, mCherry, hcRed, tagRFP, Cy5, Atto647N and Cy3.

6. The method of claim 1, wherein the multi channel marker is a virtual marker that is provided by projecting an external signal onto multiple detection areas.

7. The method of claim 1, wherein one or more of the multiple detection areas is one or more camera.

8. The method of claim 1, wherein one or more of the multiple detection areas is one or more of a charge-coupled device (CCD), an electron multiplying (EM) charge-coupled device (CCD), a complementary metal oxide semiconductor (CMOS) or a scientific CMOS (sCMOS) camera, or a Photon Multiplier Tube (PMT) or an Avalanche Photon Detector (APD) point detector.

9. The method of claim 1, wherein multiple detection areas are provided within one detection device.

10. The method of claim 1, wherein different lasers are used to image different types of molecules labeled with different fluorescent markers.

11. The method of claim 1, wherein a registration distance is achieved between detection areas that is less than or equal to 50 nm.

12. The method of claim 11, wherein a registration distance is achieved between detection areas that is less than or equal to 10 nm.

13. The method of claim 1, where beam paths to detection areas are aligned by
adjusting the optical magnification by exchanging the tube lens according to the objective magnification so that the pixel size in image space is between 64 nm and 120 nm;
aligning tube lens centered and without tip or tilt on the optical axis of the objective;
mounting a dichroic mirror so that incoming signal is split under 45 degrees, with transmitted signal having no angular offset;
installing the detection areas so that they are centered on the optical axis and in the focal plane of the tube lens and orthogonal to the optical axis;
imaging a z-focus target simultaneously on multiple detection areas with the individual signals being displayed; and
aligning z-position along the optical axis until detection area signals are identical.

14. The method of claim 1, where in the molecules are located within a cell or a transluminant sample.

15. A virtual fiducial marker for imaging comprising:
a mask containing one or more openings through which light can pass;
a first lens system on one side of the mask to deliver light onto the mask; and
a second lens system on the opposite side of the mask from the first lens system to project an image of the mask into a sample to be imaged, thereby acting as a virtual fiducial marker.

16. The virtual fiducial marker of claim 15, wherein the mask is held in a translation stage that allows movement of the mask in x and y directions.

17. The virtual fiducial marker of claim 15, wherein an image of the mask is moved by optical means to achieve displacement in the sample.

18. The virtual fiducial marker of claim 15, wherein the first lens system comprises a band pass filter.

19. The virtual fiducial marker of claim 15, wherein the marker is attached to a microscope.

20. A device for imaging molecules, the device comprising:
the virtual fiducial marker of claim 15;
an excitation source that provides light to the first lens system; and
multiple detection areas for recording imaging data from molecules labeled with fluorescent markers.
